(19) United States
(12) Patent Application Publication
(10) Pub. No.: US 2025/0092542 A1
(43) Pub. Date: Mar. 20, 2025

(54) Co/Cd-BASED BIMETALLIC METAL-ORGANIC FRAMEWORK FOR WATER-SPLITTING

(71) Applicant: KING FAHD UNIVERSITY OF PETROLEUM AND MINERALS, Dhahran (SA)

(72) Inventors: Aasif HELAL, Dhahran (SA); Md. Abdul AZIZ, Dhahran (SA); Syed Shaheen SHAH, Dhahran (SA); Mohammed FETTOUHI, Dhahran (SA)

(73) Assignee: KING FAHD UNIVERSITY OF PETROLEUM AND MINERALS, Dhahran (SA)

(21) Appl. No.: 18/470,826

(22) Filed: Sep. 20, 2023

(51) Int. Cl. C25B 11/073; C25B 1/04; C25B 11/031; C25B 11/043; C25B 11/061

(52) U.S. Cl. CPC C25B 11/073; C25B 1/04; C25B 11/031; C25B 11/043; C25B 11/061

(57) ABSTRACT

An electrode includes a metallic substrate and a layer of cobalt (Co) and cadmium (Cd) doped bimetallic metal-organic framework (BMMOF11) material at least partially covering a surface of the metallic substrate. The BMMOF11 material contains irregular shaped microcrystalline structures with pointed edges, and the irregular shaped microcrystalline structures are in the form of sheets that are stacked on top of one another. A method of making the electrode, and a method of electrochemical water splitting.

### BACKGROUND

### Technical Field

The present disclosure is directed to an electrocatalyst, particularly to a Co/Cd-based bimetallic metal-organic framework (MOF) electrocatalyst for water splitting.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

In light of the increasing global energy crises and environmental concerns, it has become imperative to develop renewable and sustainable energy sources to supplant nonrenewable resources such as fossil fuels. As an energy carrier with a very high energy density (approximately 142 MJ kg⁻¹) and zero carbon emissions, hydrogen stands out as a promising carbon-free fuel option. Under these circumstances, electrochemical water splitting, a process that converts electricity into storable hydrogen, emerges as a viable and efficient solution to address critical energy shortages and mitigate greenhouse gas emissions. Due to its potential to convert intermittent renewable energy sources into clean H₂ fuel, electrochemical water splitting has drawn increased attention. This method for producing both hydrogen (H₂) and oxygen (O₂) relies on two essential half-reactions, namely the hydrogen evolution reaction (HER) and the oxygen evolution reaction (OER) occurring on the cathode and anode within a water electrolyzer. However, the considerable overpotentials associated with these OER and HER reactions have thus far limited their practical application for mass H₂ production. Commercial electrolyzers operate at applied potentials ranging from 1.8-2.2 V, which is approximately 50% higher than the 1.23 V required for thermodynamically efficient operation at ambient temperatures. Consequently, extensive efforts have been made to the development of active electrocatalysts aimed at reducing the overpotential and enhancing the overall energy efficiency of the water-splitting process [Stefania Marini, Paolo Salvi, Paolo Nelli, Rachele Pesenti, Marco Villa, Mario Berrettoni, Giovanni Zangari, Yohannes Kiros, Electrochimica Acta 2012, 82, 384-391, Anh Linh Hoang, Sivakumar Balakrishnan, Aaron Hodges, George Tsekouras, Atheer Al-Musawi, Klaudia Wagner, Chong-Yong Lee, Gerhard F. Swiegers and Gordon G. Wallace, Sustainable Energy Fuels, 2023, 7, 31-60]. However, many of the developed catalysts fail to maintain high efficiency and stability over a wide pH range and to operate at higher overpotentials. Therefore, the quest for bimetallic electrocatalysts, such as metal-organic frameworks (MOFs), with high activity towards electrochemical water remains paramount to streamline and optimize the overall efficiency of this process.

In the field of functional nanoporous materials, metal-organic frameworks (MOFs) containing metal clusters and organic linkers, are a relatively novel class with intriguing structural and application potential. Additionally, MOFs possess crystalline porous structures, elevated surface areas, adjustable internal porosity, and an abundance of intrinsic molecular metal sites, rendering them versatile materials with a wide array of applications. Due to their porous crystalline nature, high surface area, tunable internal porosity, and abundance of inherent molecular metal sites, these materials have found widespread applications. MOFs have wide-ranging applications in energy conversion and storage, such as Zn-air batteries, hydrogen-oxygen polymer electrolyte membrane fuel cells (PEMFC) for the oxygen reduction reaction (ORR), hydrogen evolution reaction (HER), and oxygen evolution reaction (OER). However, due to the instability and poor conductivity of MOF materials, many of these instances involve using MOFs as precursors for the synthesis of metal-based compounds and porous nanocarbon materials through pyrolysis due to their high surface area, easily available active sites, and porous nature. Nonetheless, the pyrolysis process can result in the complete loss of MOFs' intrinsic active sites and ordered structure. Moreover, it may lead to agglomeration of MOF particles, diminishing electron conductivity and hampering the transfer of reactants and products during electrochemical reactions. Effective water-splitting catalysts involve noble metals such as Pt-based precious metal alloys and Ir/Ru-based oxides. However, these catalysts have disadvantages, including high cost, instability, limited availability of rare earth elements, and challenges associated with simultaneous operation when two types of catalysts are used for respective half-reactions. Consequently, there remains an ongoing need for the development of bifunctional electrocatalysts capable of simultaneously catalyzing both the HER and OER reactions in the same electrolyte solutions [Y. Xu, W. G. Tu, B. W. Zhang, S. M. Yin, Y. Y. Huang, M. Kraft, R. Xu, Adv. Mater. 2017, 29, 1605957]. Different types of transitional metals and their oxides and hydroxides [Y. Jia, L. Z. Zhang, G. P. Gao, H. Chen, B. Wang, J. Z. Zhou, M. T. Soo, M. Hong, X. C. Yan, G. R. Qian, J. Zou, A. J. Du, X. D. Yao, Adv. Mater. 2017, 29, 1700017], chalcogenides [C. Gu, S. J. Hu, X. S. Zheng, M. R. Gao, Y. R. Zheng, L. Shi, Q. Gao, X. Zheng, W. S. Chu, H. B. Yao, J. F Zhu, S. H. Yu, Angew. Chem. Int. Ed. 2018, 57, 4020-4024], and phosphides [J. H. Song, C. Z. Zhu, B. Z. Xu, S. F. Fu, M. Engelhard, R. F. Ye, D. Du, S. Beckman, Y. H. Lin, Adv. Energy Mater. 2017, 7, 1601555] have been explored as potential bifunctional catalysts for water splitting. Several MOF-derived materials have been explored as potential electrocatalysts for water splitting [H. X. Chen, Y. W. Li, H. J. Liu, Q. H. Ji, L. J. Zou, J. K. Gao, Metal-organic framework derived sulfur and nitrogen dual-doped bimetallic carbon nanotubes as electrocatalysts for oxygen evolution reaction, J. Solid State Chem. 288 (2020), 121421, T. Zhao, J. K. Gao, J. Wu, P. P. He, Y. W. Li, J. M. Yao, Energy Technol. 7 (2019), 1800969]. Nevertheless, due to their high resistance and instability, none of the MOF materials described above have been effectively employed as electrocatalysts in water splitting.

Although several electrocatalysts have been developed in the past for water splitting, there still exists a need to fabricate and explore MOF-based electrocatalysts that overcome the limitations of the art.

In view of the foregoing, it is one objective of the present disclosure to provide an electrode containing a Co/Cd MOF electrocatalyst. The electrode containing the Co/Cd MOF electrocatalyst has improved catalytic activity for electrochemical water splitting at industrial scales. A second objective of the present disclosure is to provide a method of making the electrode containing the Co/Cd MOF electrocatalyst. A further objective of the present disclosure is to provide a method of electrochemical water splitting using the electrode containing the Co/Cd MOF electrocatalyst.

### SUMMARY

In an exemplary embodiment, an electrode is described. The electrode containing a Co/Cd metal-organic framework (MOF) electrocatalyst, includes a metallic substrate and a layer of cobalt (Co) and cadmium (Cd) doped bimetallic metal-organic framework (BMMOF11) material at least partially covering a surface of the metallic substrate. In some embodiments, Co and Cd ions are uniformly distributed throughout a microporous matrix of the BMMOF11 material. In some embodiments, the BMMOF11 material includes irregular shaped microcrystalline structures with pointed edges. In some embodiments, the irregular shaped microcrystalline structures are in the form of sheets that are stacked on top of one another.

In some embodiments, the metallic substrate is at least one metal foam selected from the group consisting of an aluminum foam, a nickel foam, a titanium foam, a titanium alloy foam, an aluminum alloy foam, a magnesium alloy foam, a nickel alloy foam, and a steel foam.

In some embodiments, the metallic substrate is a nickel foam.

In some embodiments, the BMMOF11 material has a formula [CoCd(BTC)(NO₃)(DMF)₂]. In some embodiments, BTC is a tricarboxylate linker that is covalently bonded to at least one Co ion and at least one Cd ion at the same time.

In some embodiments, the layer of the BMMOF11 material has an average pore size of 0.5 to 10 micrometers (μm).

In some embodiments, the BMMOF11 material is a crystalline material having a single crystal lattice structure.

In some embodiments, the electrode has a current density of about 120 to 130 milliamperes per square centimeter (mA/cm²) at 1.9 volts relative to the reversible hydrogen electrode (V_{RHE}).

In some embodiments, the electrode has an electrochemical water oxidation starting potential of about 1.62 V_{RHE}.

In some embodiments, the electrode has an overpotential of about 0.4 V_{RHE} for a current density of 10 mA/cm².

In an exemplary embodiment, a method of forming the electrode is described. The method includes mixing and dissolving particles of the BMMOF11 material in a solvent to form a solution, aerosolizing the solution to form an aerosol, placing the metallic substrate in a heating chamber, and passing the aerosol through the heating chamber with the aid of a carrier gas. In some embodiments, the carrier gas contains nitrogen. In some embodiments, the metallic substrate is in direct contact with the aerosol. In some embodiments, the method of forming the electrode further includes heating the metallic substrate in the heating chamber to form the electrode having the layer of the BMMOF11 material at least partially covered on the surface of the metallic substrate.

In some embodiments, the solvent is at least one selected from the group consisting of a ketone solvent, an ester solvent, an alcohol solvent, an amide solvent, and an ether solvent.

In some embodiments, the aerosolizing homogeneously disperses particles of the BMMOF11 material on the surface of the metallic substrate.

In some embodiments, a method of aerosolizing is described. The aerosolizing is performed with an aerosol generator includes a fluid chamber having a housing inlet, a housing outlet, and a vent, a vibrating element operably coupled to the support plate for generating the aerosol. In some embodiments, the solution is introduced into the fluid chamber via the housing inlet. In some embodiments, the fluid chamber is in fluid communication with the heating chamber via the housing outlet. In some embodiments the carrier gas is introduced into the fluid chamber via the vent, thereby carrying the aerosol into the heating chamber.

In some embodiments, the method of making the electrode further includes forming the BMMOF11 material by mixing a Co salt, a Cd salt, and a tricarboxylate linker in N,N-dimethylformamide (DMF) to form a mixture and heating. In some embodiments, a molar ratio of the Co ion to the Cd ion is about 1:1. In some embodiments a molar ratio of the tricarboxylate linker to a total number of moles of the Co salt and the Cd salt is about 1:6. The forming the BMMOF11 material of the method of making the electrode further include cooling the mixture after the heating thereby allowing the BMMOF11 material to precipitate from the mixture, and removing the BMMOF11 material in the form of a precipitate from the mixture, washing and drying.

In some embodiments, the Co salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate.

In some embodiments, the Cd salt includes cadmium sulfate, cadmium acetate, cadmium citrate, cadmium iodide, cadmium chloride, cadmium perchlorate, cadmium nitrate, cadmium phosphate, cadmium triflate, cadmium bis(trifluoromethanesulfonyl)imide, cadmium tetrafluoroborate, cadmium bromide, and/or its hydrate.

In an exemplary embodiment, a method of electrochemical water splitting is described. The method of electrochemical water splitting includes applying a potential of greater than 0 to 2.0 V_{RHE} to an electrochemical cell to form hydrogen and oxygen and separately collecting H₂-enriched gas and O₂-enriched gas. In some embodiments, the electrochemical cell includes the Co/Cd MOF-based electrode, and a counter electrode, wherein the electrochemical cell is at least partially submerged in an electrolyte.

In some embodiments, the counter electrode is made from a material selected from the group consisting of platinum, gold, and carbon.

In some embodiments, the electrolyte contains an aqueous solution of a base at a concentration of 0.1 to 3 M.

In some embodiments, the base is at least one selected from the group consisting of NaOH, KOH, LiOH, Ba(OH)₂, and Ca(OH)₂.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart depicting a method of making a cobalt (Co) and cadmium (Cd) doped bimetallic metal-organic framework (BMMOF11) material-based electrode, according to certain embodiments;

FIG. 1B is a flowchart depicting a method of forming the BMMOF11, according to certain embodiments;

FIG. 1C is a flowchart depicting a method of electrochemical water splitting, according to certain embodiments;

FIG. 2 is an Oak Ridge Thermal Ellipsoid Plot (ORTEP) diagram of the Co secondary building unit (SBU) in a compound of formula 1, [CoCd(BTC)(NO₃)(DMF)₂], according to certain embodiments;

FIG. 3 is an ORTEP diagram of the Cd SBU in the compound of formula 1, [CoCd(BTC)(NO₃)(DMF)₂], according to certain embodiments;

FIG. 4A depicts a single-crystal structure of the BMMOF11 constructed from benzene-1,3,5-tricarboxylate (BTC), Co²⁺, and Cd²⁺ building blocks, according to certain embodiments;

FIG. 4B depicts a single unit showing the binding of the BTC with Co²⁺ and Cd²⁺, according to certain embodiments;

FIG. 4C depicts an inorganic SBU including Co²⁺ and Cd²⁺, according to certain embodiments;

FIG. 5 shows a powder X-ray diffraction (PXRD) analysis of the BMMOF11 and its comparison with the simulated pattern of the BMMOF11 and PXRD of the BMMOF11 after electrocatalytic application, according to certain embodiments;

FIG. 6 is a Fourier Transform Infrared (FTIR) spectra of the BMMOF11, according to certain embodiments;

FIG. 7 shows a nitrogen adsorption isotherm of the BMMOF11, according to certain embodiments;

FIG. 8 shows a plot for thermogravimetric analysis (TGA) of the BMMOF11, according to certain embodiments;

FIG. 9 shows a Field Emission Scanning Electron Microscopy (FESEM) image of the BMMOF11, according to certain embodiments;

FIG. 10A shows a comparison of cyclic voltammetry (CV) curves for the BMMOF11 immobilized on nickel (Ni) foam (NF)(BMMOF11/NF) and bare nickel foam (NF) electrodes in 1 M KOH aqueous electrolyte, measured at a scan rate of 50 mV/sec, according to certain embodiments;

FIG. 10B shows CV curves of the BMMOF11/NF electrode at different scan rates, according to certain embodiments;

FIG. 10C shows amperometric analysis (stability) of the BMMOF11/NF electrode in 1 M KOH at 1.9 V vs. reversible hydrogen electrode (RHE), according to certain embodiments;

FIG. 10D shows Nyquist plots of the BMMOF11/NF electrode before and after stability performance, according to certain embodiments;

FIG. 11A shows CV curves of the BMMOF11/NF electrode in 1 M KOH aqueous electrolyte at different scan rates 10, 20, 30, 40, 50, 60, 70, 80, 90, and 100 mV/sec, according to certain embodiments;

FIG. 11B shows the corresponding anodic charging current of the CV measurements, measured at 1.2 V vs. RHE, plotted as a function of scan rate, according to certain embodiments; and

FIG. 11C shows a Tafel polarization plot for the BMMOF11/NF electrocatalyst, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, “compound” is intended to refer to a chemical entity, whether as a solid, liquid, or gas, and whether in a crude mixture or isolated and purified.

As used herein, “particle size” and “pore size” may be thought of as the lengths or longest dimensions of a particle and of a pore opening, respectively.

As used herein, the term “electrode” refers to an electrical conductor used to contact a non-metallic part of a circuit e.g., a semiconductor, an electrolyte, a vacuum, or air.

As used herein, the term “electrochemical cell” refers to a device capable of either generating electrical energy from chemical reactions or using electrical energy to cause chemical reactions.

As used herein, the term “electrolyte” is generally refers to a solution that has the ability to conduct electricity when dissolved in a polar solvent.

As used herein, the term “water splitting” generally refers to the chemical reaction in which water is broken down into oxygen and hydrogen.

2H₂O→2H₂+O₂

As used herein, the term “current density” generally refers to the amount of electric current traveling per unit cross-section area.

As used herein, the term “Tafel slope” generally refers to the relationship between the overpotential and the logarithmic current density.

As used herein, the term “aerosolizing” generally refers to a process of intentionally oxidatively converting solution for the purpose of delivering the oxidized aerosols to the heating chamber.

As used herein, the term “aerosol” generally refers to extremely small solid particles, or very small liquid droplets, suspended in the atmosphere.

The present disclosure is intended to include all hydration states of a given compound or formula, unless otherwise noted or when heating a material.

The present disclosure is intended to include all isotopes of a given compound or formula, unless otherwise noted.

As used herein, the term “overpotential” generally refers to the difference in potential that exists between a thermodynamically determined reduction potential of a half-reaction and the potential at which the redox event is experimentally observed. The term is directly associated with a cell's voltage efficacy. In an electrolytic cell, the occurrence of overpotential implies that the cell needs more energy as compared to that thermodynamically expected to drive a reaction. The quantity of overpotential is specific to each cell design and varies across cells and operational conditions, even for the same reaction. Overpotential is experimentally measured by determining the potential at which a given current density is reached.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

Aspects of the present disclosure are directed to a cobalt (Co) and cadmium (Cd) doped bimetallic metal-organic framework electrocatalyst (BMMOF11). The prepared BMMOF11 was immobilized on nickel (Ni) foam (NF)(designated as BMMOF11/NF) to study the electrocatalytic properties towards water oxidation.

An electrode is described. The electrode includes a metallic substrate. In some embodiments, the metallic substrate is at least one metal foam selected from an aluminum foam, a nickel foam, a titanium foam, a titanium alloy foam, an aluminum alloy foam, a magnesium alloy foam, a nickel alloy foam, and a steel foam. In a specific embodiment, the metallic substrate is a nickel foam.

In some embodiments, the electrode further includes a layer of cobalt (Co) and cadmium (Cd) doped bimetallic metal-organic framework (BMMOF11) material, at least partially covering the surface of the metallic substrate. In some embodiments, the metallic substrate has two sides. In some embodiments, only one of the two sides of the metallic substrate is covered by the BMMOF11 material. In some embodiments, the BMMOF11 material covers at least 40%, preferably 50%, preferably 60%, preferably 70%, preferably 80%, preferably 90%, and preferably 95% of the metallic substrate, each % based on a total surface area of the metallic substrate. Other ranges are also possible. In some further embodiments, the Co and Cd ions are uniformly distributed throughout a microporous matrix of the BMMOF11 material.

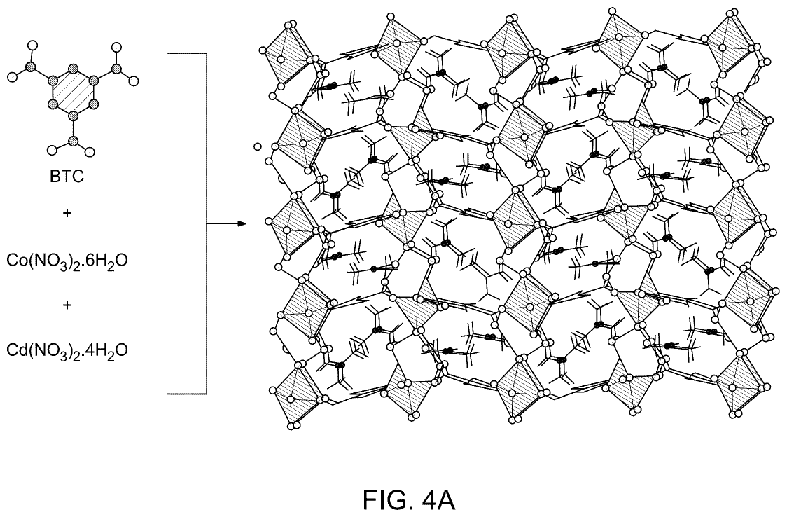

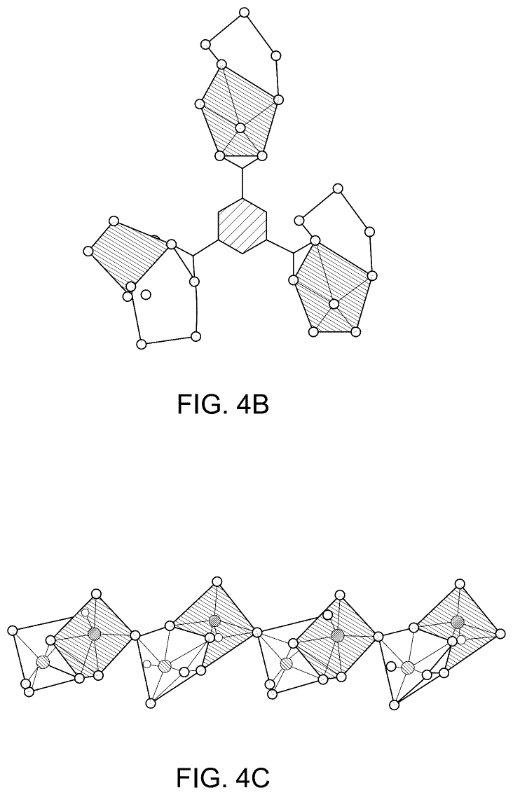

In some embodiments, the BMMOF11 material has a formula [CoCd(BTC)(NO₃)(DMF)₂], wherein BTC is a tricarboxylate linker that is bonded, e.g., covalently, to at least one Co ion and at least one Cd ion at the same time, as depicted in FIGS. 4A to 4C. In some embodiments, the BMMOF11 material is a microcrystalline material having a single crystal lattice structure. A crystalline morphology means that the BMMOF11 material includes at least 90 wt %, preferably at least 95 wt %, more preferably at least 99 wt % crystalline BMMOF11 particles relative to the total weight of the BMMOF11 particles. Other ranges are also possible.

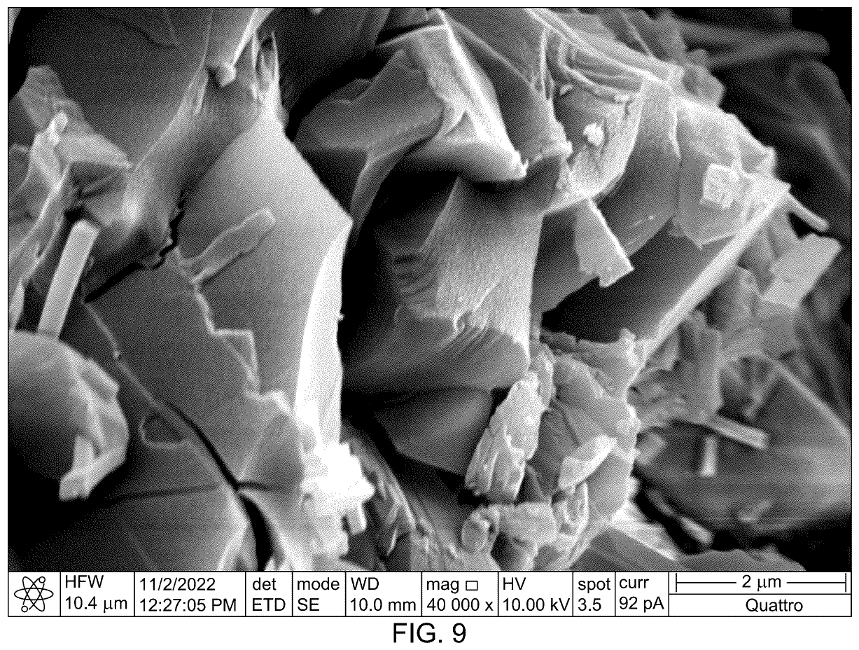

Referring to FIG. 9, the BMMOF11 material contains irregular-shaped microcrystalline structures with pointed edges, e.g., edges having one or more peaks. The irregular-shaped microcrystalline structures are in the form of sheets that are stacked on top of one another. In some embodiments, the BMMOF11 material may exist in other morphological forms such as wires, rods, spheres, crystals, rectangles, triangles, pentagons, hexagons, prisms, disks, cubes, ribbons, blocks, beads, toroids, discs, barrels, granules, whiskers, flakes, foils, powders, boxes, stars, tetrapods, belts, flowers, and mixtures thereof.

In some embodiments, the layer of the BMMOF11 material has an average pore size of 0.1 to 20 micrometers (μm), preferably 0.5 to 10, preferably 1.0-9.5, preferably 1.5-9.0, preferably 2.0-8.5, preferably 2.5-8.0, preferably 3.0-7.5, preferably 3.5-7.0, preferably 4.0-6.5, preferably 4.5-6.0, and preferably 5.0-5.5 μm. Other ranges are also possible.

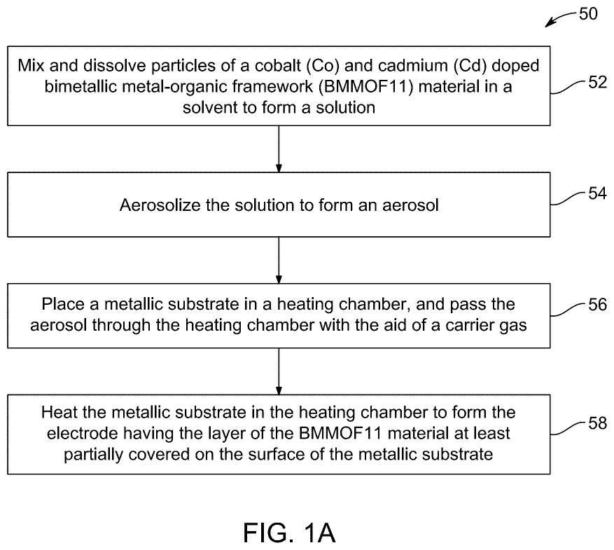

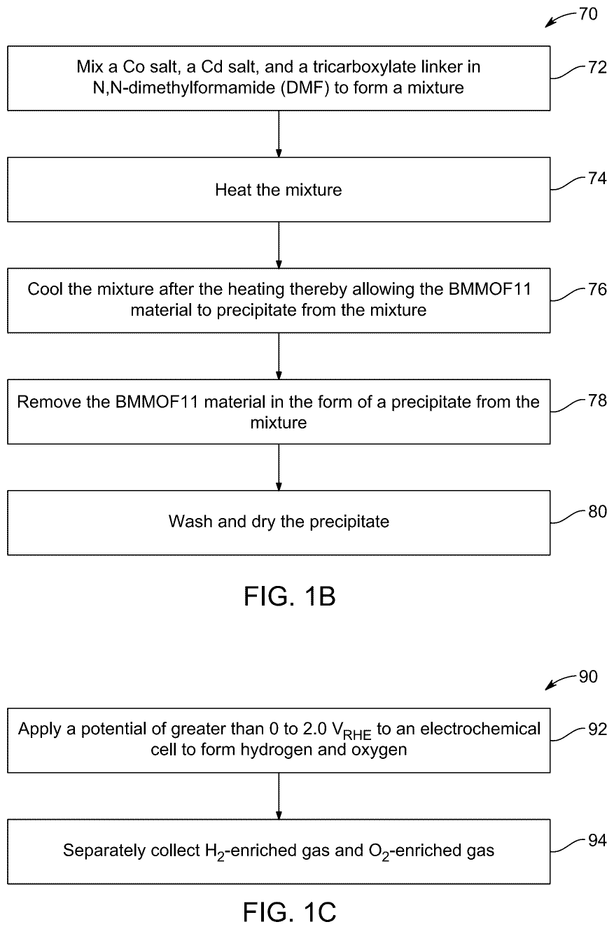

FIG. 1A illustrates a flow chart of a method 50 of preparing a cobalt (Co) and cadmium (Cd) doped bimetallic metal-organic framework (BMMOF11) material-based electrode. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing and dissolving particles of the BMMOF11 material in a solvent to form a solution. The mixing may be carried out manually or with the help of a stirrer. In some embodiments, the solvent is at least one selected from the group consisting of a ketone solvent, an ester solvent, an alcohol solvent, an amide solvent, and an ether solvent. Suitable examples of ketone solvents include acetone, acetophenone, and/or combinations thereof. Suitable examples of ester solvents include ethyl acetate, methyl salicylate, and/or combinations thereof. Suitable examples of alcohol solvents include ethanol, isopropyl alcohol, and/or combinations thereof. Suitable examples of amide solvents include dimethylformamide (DMF), acetamide, and/or combinations thereof. Suitable examples of ether solvents include diethyl ether and Tetrahydrofuran (THF). In an embodiment, the solvent is water/ethanol solution having a water to ethanol volume ratio of 10:1 to 1:10, preferably 1:5 to 5:1, or even more preferably about 1:1. Other ranges are also possible. The mixing is carried out till the particles of the BMMOF11 material are fully dissolved in the solvent, resulting in a homogenous solution. In some embodiments, the BMMOF11 material is present in the solution at a concentration of 1 to 10 milligrams per milliliter (mg/mL), preferably 2 to 8 mg/mL, preferably 3 to 6 mg/mL, or even more preferably about 4 mg/mL. Other ranges are also possible. In some further embodiments, the solution further includes a Nafion solution containing a sulfonated tetrafluoroethylene based fluoropolymer-copolymer. In some embodiments, the sulfonated tetrafluoroethylene based fluoropolymer-copolymer is present in the Nafion solution at a concentration of 0.1 to 10 wt. % based on a total weight of the Nafion solution, preferably 1 to 8 wt. %, preferably 2 to 6 wt. %, or even more preferably about 5 wt. % based on a total weight of the Nafion solution. Other ranges are also possible.

At step 54, the method 50 includes aerosolizing the solution to form an aerosol. The aerosolizing is performed with an aerosol generator, including a fluid chamber having a housing inlet, a housing outlet, and a vent, a vibrating element operably coupled to the support plate for generating the aerosol. The solution is introduced into the fluid chamber via the housing inlet. The fluid chamber is in fluid communication with the heating chamber via the housing outlet. A carrier gas is introduced into the fluid chamber via the vent, thereby carrying the aerosol into the heating chamber.

At step 56, the method 50 includes placing the metallic substrate in a heating chamber, and passing the aerosol through the heating chamber with the aid of a carrier gas. The aerosolizing homogeneously disperses particles of the BMMOF11 material on the surface of the metallic substrate. In some embodiments, the carrier gas is nitrogen, hydrogen, helium, and argon. In a specific embodiment, the carrier gas is nitrogen. In some embodiments, the metallic substrate is in direct contact with the aerosol.

At step 58, the method 50 includes heating the metallic substrate in the heating chamber to form the electrode having the layer of the BMMOF11 material at least partially covered on the surface of the metallic substrate.

In some other embodiments, the electrode may be prepared by drop casting the solution prepared according to step 52 on a surface of the metallic substrate to form a sample. In some further embodiments, the sample is dried in an oven at a temperature of 30 to 100° C., preferably 40 to 80° C., or even more preferably about 60° C., to form the electrode containing the layer of the BMMOF11 material. Other ranges are also possible.

FIG. 1B illustrates a flow chart of a method 70 of forming the BMMOF11 material. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes mixing a Co salt, a Cd salt, and a tricarboxylate linker in N,N-dimethylformamide (DMF) to form a mixture. The mixing may be carried out manually or with the help of a stirrer. The Co salt may include cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate. The Cd salt may include cadmium sulfate, cadmium acetate, cadmium citrate, cadmium iodide, cadmium chloride, cadmium perchlorate, cadmium nitrate, cadmium phosphate, cadmium triflate, cadmium bis(trifluoromethanesulfonyl)imide, cadmium tetrafluoroborate, cadmium bromide, and/or its hydrate. In a preferred embodiment, the cobalt salt is cobalt nitrate (Co(NO₃)₂·6H₂O) and the cadmium salt is cadmium nitrate (Cd(NO₃)₂·4H₂O). In some embodiments, a molar ratio of the Co ion to the Cd ion is in a range of 1:10 to 10:1, preferably 1:5 to 5:1, preferably 1:4 to 4:1, preferably 3:1 to 1:3, preferably 1:2 to 2:1, and more preferably 1:1. Other ranges are also possible. In a specific embodiment, the molar ratio of the Co ion to the Cd ion is 1:1. Suitable examples of tricarboxylate linkers include benzene-1,3,5-tricarboxylic acid (trimesic acid), biphenyl-3,4′,5-tricarboxylic acid, 3,2′,4′-biphenyl-tricarboxylic acid. In a preferred embodiment, the tricarboxylate linker is trimesic acid. In some embodiments, the molar ratio of the tricarboxylate linker to the total number of moles of the Co salt and the Cd salt is in the range of 1:1 to 1:10, preferably 1:2 to 1:9, preferably 1:3 to 1:8, preferably 1:4 to 1:7, preferably 1:5 to 1:6, or even more preferably 1:6. Other ranges are also possible.

At step 74, the method 70 includes heating the mixture. The heating of the precipitate can be done by using heating appliances such as ovens, microwaves, autoclaves, hot plates, heating mantles and tapes, oil baths, salt baths, sand baths, air baths, hot-tube furnaces, and hot-air guns. In a preferred embodiment, the mixture was heated at 80 to 200° C., preferably 100 to 150° C., or even more preferably about 120° C. in stainless-steel autoclave. Other ranges are also possible.

At step 76, the method 70 includes cooling the mixture after the heating, thereby allowing the BMMOF11 material to precipitate from the mixture. The mixture is cooled at room temperature causing precipitation of the BMMOF11 material from the mixture.

At step 78, the method 70 includes removing the BMMOF11 material in the form of a precipitate from the mixture. The precipitate can be removed by filtration or centrifugation.

At step 80, the method 70 includes washing and drying the precipitate. The washing of the precipitate is done by using a solvent like distilled water, alcohol, or a mixture thereof. The drying of the precipitate is done by air-drying or by using heating appliances such as ovens, hot plates, hot-air guns, and heating mantles. In a preferred embodiment, the drying is carried out at a temperature range of 60-90° C., preferably 61-89° C., 62-88° C., 63-87° C., 64-86° C., 65-85° C., 66-84° C., 67-83° C., 68-82° C., and 70-80° C., preferably 80° C. to remove moisture. The drying is carried out at a temperature of 80° C. to remove moisture.

The structures of the BMMOF11 material may be characterized by Fourier transforms infrared spectroscopy (FT-IR). In some embodiments, the FT-IR may be collected in a Nicolet 6700 Thermo Scientific instrument acquired in a range of 4000 to 400 centimeter inverse (cm-1) at 4 cm-1 resolution. 20 scans were carried out for each sample.

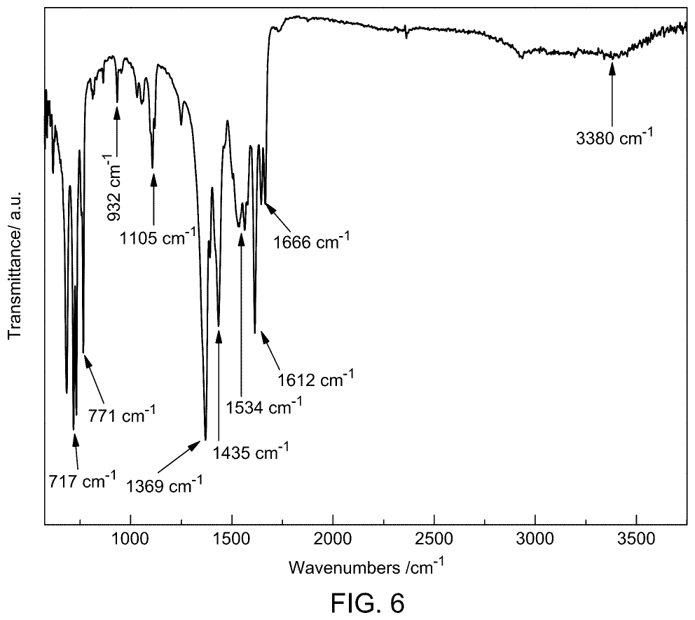

In some embodiments, the BMMOF11 material has peaks at about 717 cm⁻¹, about 771 cm⁻¹, about 932 cm⁻¹, about 1105 cm⁻¹, about 1369 cm⁻¹, about 1435 cm⁻¹, about 1534 cm⁻¹, about 1612 cm⁻¹, about 1666 cm⁻¹, and about 3380 cm⁻¹ in a Fourier transform infrared spectrum (FT-IR), as depicted in FIG. 6.

The crystalline structure of the BMMOF11 material may be characterized by X-ray diffraction (XRD), respectively. In some embodiments, the XRD patterns are collected in a Powder X-ray diffraction (XRD, Bruker D8 Advance diffractometer) equipped with a Cu-Kα radiation source (λ=0.15406 nm) for a 20 range extending between 5 and 80°, preferably 15 and 70°, further preferably 30 and 60° at an angular rate of 0.005 to 0.04°s⁻¹, preferably 0.01 to 0.03° s⁻¹, or even preferably 0.02° s⁻¹.

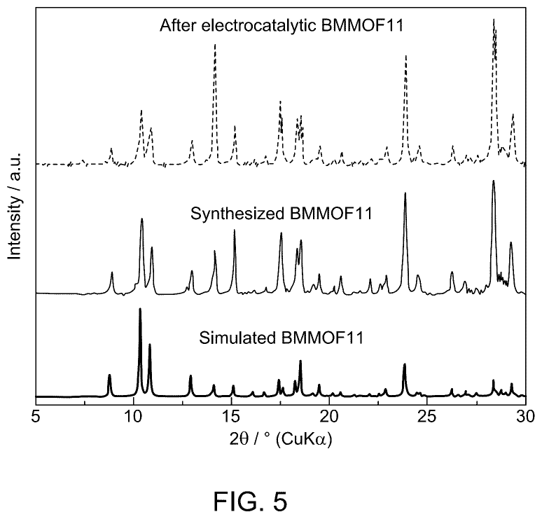

In some embodiments, the BMMOF11 material has peaks with a 2 theta (0) value in a range of 7 to 12° in an X-ray diffraction (XRD) spectrum, 13 to 15°, 17 to 20°, 22 to 25°, and 27 to 30°, as depicted in FIG. 5. Other ranges are also possible.

As used herein, the term “N₂ adsorption/desorption method” generally refers to a technique used to measure the specific surface area of a solid material, such as the BMMOF11 material. In some embodiments, the BMMOF11 material is exposed to a stream of nitrogen gas at low temperature and pressure. The nitrogen gas is adsorbed onto the surface of the BMMOF11 material, filling the pores and creating a monolayer of adsorbed nitrogen. In some further embodiments, the amount of nitrogen adsorbed at a given pressure is measured using a gas adsorption instrument, such as a Micromeritics ASAP 2020 instrument. In some preferred embodiments, the BET analysis is performed on an analyzer according to the software manual. In some more preferred embodiments, the nitrogen gas is gradually removed from the BMMOF11 material, causing the desorption of the adsorbed nitrogen. The amount of nitrogen desorbed at a given pressure is also measured using the gas adsorption instrument. By analyzing the amount of nitrogen adsorbed and desorbed, the specific surface area of the BMMOF11 material can be calculated using the BET (Brunauer-Emmett-Teller) and Barrett, Joyner and Halenda (BJH) equation.

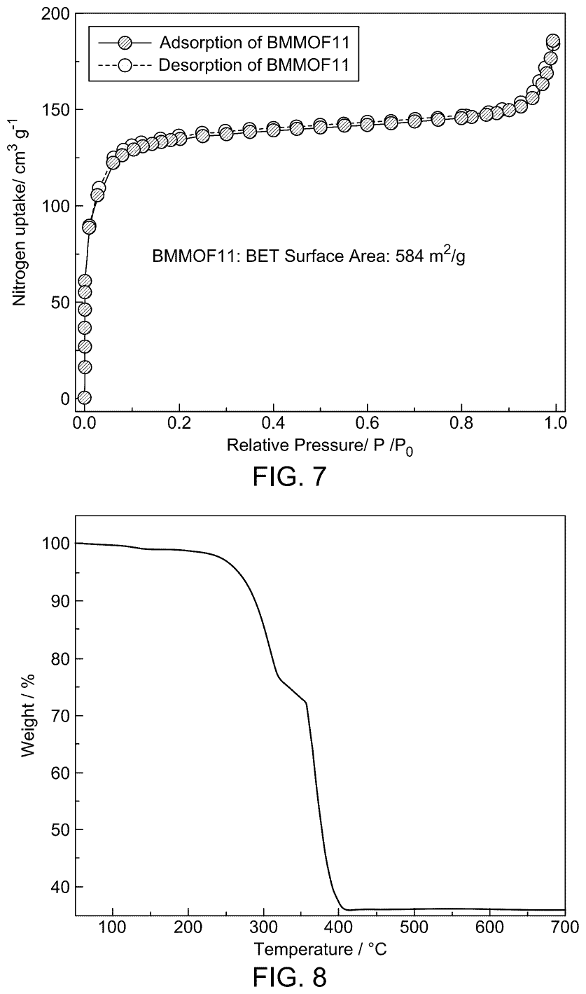

In an embodiment, the BMMOF11 material having a specific surface area of about 400 to 800, preferably 450-750, preferably 500-700, preferably 550-650, or even more preferably about 584 square meters per gram (m² g⁻¹), as depicted in FIG. 7. Other ranges are also possible.

The structures of the BMMOF11 material may be characterized Thermogravimetric analysis (TGA). In some embodiments, the TGA may be collected in a TA Q500 instrument acquired by heating the BMMOF11 material in an alumina pan under an airflow in a range of 20 to 100, preferably about 60 mL min⁻¹ with a gradient of 5 to 20, preferably about 10° C. min-1 in the temperature range of 30-800° C. Other ranges are also possible.

In some embodiments, the BMMOF11 material has a first weight loss in a range of 15 to 30 wt. %, preferably about 23 wt. % based on a total weight of the BMMOF11 material at a temperature of about 300° C., as depicted in FIG. 8. In some further embodiments, the BMMOF11 material has a second weight loss in a range of 30 to 50 wt. %, preferably about 41 wt. % based on the total weight of the BMMOF11 material at a temperature of about 350° C., as depicted in FIG. 8. Other ranges are also possible.

FIG. 1C illustrates a flow chart of a method 90 of electrochemical water splitting. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes applying a potential of greater than 0 to 2.0 V_{RHE} to an electrochemical cell to form hydrogen and oxygen. The electrochemical cell includes the BMMOF11-based electrode, and a counter electrode. In some embodiments, the counter electrode is made from a material selected from the group consisting of platinum, gold, and carbon. In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. Other ranges are also possible. The form of the counter electrode may be generally relevant only in that it needs to supply sufficient current to the electrolyte solution to support the current required for the electrochemical reaction of interest. The material of the counter electrode should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or might lead to undesirable contamination of either electrode.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be a standard hydrogen electrode (SHE), a normal hydrogen electrode (NHE), a reversible hydrogen electrode (RHE), a saturated calomel electrode (SCE), a copper-copper (II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, a reference electrode is RHE. However, in some embodiments, the electrochemical cell does not include a third electrode.

In some embodiments, the electrochemical cell is at least partially submerged in an electrolyte, preferably 50%, preferably 60%, or more preferably at least 70%. In some embodiments, the aqueous solution includes water and a base. The water may be tap water, distilled water, bidistilled water, deionized water, deionized distilled water, reverse osmosis water, and/or some other water. In some embodiments, the electrolyte includes the aqueous solution of the base at a concentration of 0.1-3 M, preferably 0.2-2.9 M, preferably 0.3-2.8 M, preferably 0.4-2.7 M, preferably 0.5-2.6 M, preferably 0.6-2.5 M, preferably 0.7-2.4 M, preferably 0.8-2.3 M, preferably 0.9-2.2 M, preferably 1.0-2.1 M, preferably 1.1-2.0 M, preferably 1.2-1.9 M, preferably 1.3-1.8 M, preferably 1.4-1.7 M, and preferably 1.5-1.6 M. In a preferred embodiment, the electrolyte includes the aqueous solution of the base at a concentration of 1 M. In some embodiments, the base is at least one selected from the group consisting of NaOH, KOH, LiOH, Ba(OH)₂, and Ca(OH)₂. In an alternative embodiment, an organic base may be used, such as sodium acetate. Preferably, to maintain uniform concentrations and/or temperatures of the electrolyte solution, the electrolyte solution may be stirred or agitated during the step of the subjecting. The stirring or agitating may be done intermittently or continuously. This stirring or agitating may be done by a magnetic stir bar, a stirring rod, an impeller, a shaking platform, a pump, a sonicator, a gas bubbler, or some other device. Preferably the stirring is done by an impeller or a magnetic stir bar.

In some embodiments, an electrochemical water oxidation's starting potential of about 1 to 3 V_{RHE}, preferably about 1.62 V_{RHE}. In some embodiments, the working electrode has a current density of about 120-130 milliamperes per square centimeter (mA/cm²), preferably 121-129, preferably 122-128, preferably 123-127, preferably 124-126 mA/cm² at 1.9 volts relative to the reversible hydrogen electrode (V_{RHE}). In some embodiments, the working electrode has an overpotential of about 0.4 V_{RHE} for a current density of 10 mA/cm². Other ranges are also possible.

In some embodiments, that the BMMOF11/NF has a current density of 124 mA/cm² at 1.9 V (vs. RHE) and electrochemical water oxidation starting potential of about 1.62 V_{RHE}. The BMMOF11/NF electrocatalyst has a substantially low overpotential of about 0.4 V_{RHE} to achieve a current density of about 10 mA/cm². The long-term electrolysis stability test using the electrode containing the BMMOF11 material showed that it can be utilized to continuously split water into O₂ and H₂ at a current density of about 70 mA/cm² with an applied voltage of about 1.9 V_{RHE}. Other ranges are also possible.

At step 94, the method 90 includes separately collecting H₂-enriched gas and 02-enriched gas. The oxygen may be generated by decomposing water into H₂ and O₂. In one embodiment, the space above each electrode may be confined to a vessel in order to receive or store the evolved gases from one or both electrodes. The collected gas may be further processed, filtered, or compressed. Preferably the H₂-enriched gas is collected above the cathode, and the 02-enriched gas is collected above the anode. The electrolytic cell, or an attachment, may be shaped so that the headspace above the working electrode is kept separate from the headspace above the reference electrode. In one embodiment, the H₂-enriched gas and the O₂-enriched gas are not 100 vol % H₂ and 100 vol % 02, respectively. For example, the enriched gases may also comprise N₂ from the air, water vapor, and other dissolved gases from the electrolyte solution. The H₂-enriched gas may also comprise O₂ from the air. The H₂-enriched gas may comprise greater than 20 vol % H₂, preferably greater than 40 vol % H₂, more preferably greater than 60 vol % H₂, and even more preferably greater than 80 vol % H₂, relative to a total volume of the receptacle collecting the evolved H₂ gas. The O₂-enriched gas may comprise greater than 20 vol % O₂, preferably greater than 40 vol % O₂, more preferably greater than 60 vol % O₂, and even more preferably greater than 80 vol % O₂, relative to a total volume of the receptacle collecting the evolved O₂ gas. In some embodiments, the evolved gases may be bubbled into a vessel comprising water or some other liquid, and higher concentrations of O₂ or H₂ may be collected. In one embodiment, evolved O₂ and H₂, or H₂-enriched gas and O₂-enriched gas, may be collected in the same vessel.

In an alternative embodiment, the electrocatalyst of the present disclosure may be used in the field of batteries, fuel cells, photochemical cells, water splitting cells, electronics, water purification, hydrogen sensors, semiconductors (such as field effect transistors), magnetic semiconductors, capacitors, data storage devices, biosensors (such as redox protein sensors), photovoltaics, liquid crystal screens, plasma screens, touch screens, OLEDs, antistatic deposits, optical coatings, reflective coverings, anti-reflection coatings, and/or reaction catalysis.

### EXAMPLES

The following examples demonstrate an electrode including a Co/Cd MOF electrocatalyst as described herein. The examples are provided solely for illustration and are not to be construed as limitations of the present disclosure, as many variations thereof are possible without departing from the spirit and scope of the present disclosure.

### Example 1: Materials and General Methods

Trimesic acid (98% purity) (TPA), Cobalt nitrate hexahydrate (98.0% purity) (Co(NO₃)₂·6H₂O), Cadmium nitrate tetrahydrate (98.0% purity) (Cd(NO₃)₂·4H₂O) acetic acid (99.7% purity), N,N-dimethylformamide (DMF; 99.8% purity), dichloromethane (99.8% extra dry grade), potassium hydroxide (KOH) (99.95% purity), and Nafion, were purchased from Sigma Aldrich Corporation. All chemicals were used without further purification. Nickel foam (NF, 0.5 mm, 110PPI) was purchased from the Minihua store on AliExpress.com. Water was double distilled and filtered through a Millipore membrane.

### Example 2: Instrumentation

Powder X-ray diffraction (PXRD) patterns of the samples were recorded using a Rigaku MiniFlex diffractometer, which was equipped with Cu-Kα radiation (manufactured by Rigaku, Japan). The data were acquired over the range of 5° and 40°. The Fourier Transform Infrared (FT-IR) spectra of the MOF were obtained using a Nicolet 6700 Thermo Scientific instrument in the range of 400-4000 cm⁻¹, using KBr (ThermoFisher Scientific, Waltham, Massachusetts, USA). Thermogravimetric analysis (TGA) of the samples was performed using a TA Q500. An activated sample of bimetallic MOF (10 mg) was heated in an alumina pan under airflow (60 mL min-1) with a gradient of 10° C. min⁻¹ in the temperature range of 30-800° C. The surface area was obtained from the nitrogen adsorption isotherm of the MOF by using the Micromeritics ASAP 2020 instrument (Micrometrics, 4356 Communications Dr. Norcross, GA 30093-2901, U.S.A.). A liquid nitrogen bath was used for the measurements at 77 K. Elemental microanalyses (EA) were performed using a PerkinElmer-EA 2400 elemental analyzer (manufactured by PerkinElmer, Waltham, Massachusetts, United States). The surface morphology of these materials was discerned using a field emission scanning electron microscope (FESEM, LYRA 3 Dual Beam, Tescan), which operated at 30 kV. The FESEM samples were prepared from suspension in ethanol. All electrochemical analyses were carried out by using a CHI workstation (CHI-760E potentiostat).

### Example 3: Single Crystal X-Ray Structure Analysis

Single crystal X-ray data were collected on a Bruker D8 Quest diffractometer (MoKα radiation λ=0.71073 \acute{Å}) at 298 K using a Bruker APEX3 software package [Bruker, APEX3. Bruker AXS Inc., Madison, Wisconsin, USA (2017), which is incorporated herein by reference in its entirety]. Data reduction was performed using SAINT [Bruker SAINT, Bruker AXS Inc., Madison, USA (2017)]. Multi-scan absorption correction was performed using SADABS [G. M. Sheldrick, SADABS, Bruker AXS Inc., Madison, Wisconsin, USA (2017), which is incorporated herein by reference in its entirety]. The structure was solved by direct methods with SHELXS using SHELXTL package and refined using full-matrix least-squares procedures on F² via the program SHELXL-2014 [G. M. Sheldrick, Acta Cryst, C71 (2015) 3-8, which is incorporated herein by reference in its entirety]. All hydrogen atoms were included at calculated positions using a riding model with C—H distances of 0.93 Å for sp² carbons and 0.96 Å for sp³ carbons with the isotropic displacement parameter Uᵢₛₒ(H)=1.2 U_{eq}(C) and Uᵢₛₒ(H)=1.5 U_{eq}(C) respectively. Molecular graphics were obtained using ORTEP3 [L. J. Farrugia J. Appl. Cryst. (2012). 45, 849-854, which is incorporated herein by reference in its entirety]. The X-ray data have been deposited with the Cambridge Structural Database (deposit number 2109278). These data can be obtained from The Cambridge Crystallographic Data Centre via www.ccdc.cam.ac.uk/data_request/cif. Crystal data and details of the data collection and refinements are given in Tables 1 and 2.

TABLE 1
Crystal and structure refinement data for the BMMOF11 material

| | |
|---|---|
| Empirical formula | C₁₅H₁₇CdCoN₃O₁₁ |
| Formula weight | 586.65 |
| Temperature | 296(2) K |
| Wavelength | 0.71073 Å |
| Crystal system | Monoclinic |
| Space group | P 2₁/c |
| Unit cell dimensions | a = 10.1224(3) Å |
| | b = 16.3480(5) Å |
| | c = 12.6545(4) Å |
| | β = 96.321(2)° |
| Volume | 2081.35(11) Å³ |
| Z | 4 |
| Density (calculated) | 1.872 g/cm³ |
| Absorption coefficient | 1.881 mm⁻¹ |
| F(000) | 1164 |
| Theta range for data collection | 2.024 to 28.357°. |
| Index ranges | −13 ≤ h ≤ 13, −21 ≤ k ≤ |
| | 21, −16 ≤ 1 ≤ 16 |
| Reflections collected | 109228 |
| Independent reflections | 5204 [R(int) = 0.0501] |
| Completeness to theta = 25.242° | 99.9% |
| Refinement method | Full-matrix least-squares on F² |
| Data/restraints/parameters | 5204/0/284 |
| Goodness-of-fit on F² | 1.187 |
| Final R indices [I > 2sigma(I)] | R₁ = 0.0790, wR₂ = 0.2113 |
| R indices (all data) | R₁ = 0.0803, wR₂ = 0.2127 |
| Largest diff. peak and hole | 4.837 and −2.055 e · Å⁻³ |

TABLE 2
Selected Bond lengths [Å] and angles [°]
for the BMMOF11 material

| | |
|---|---|
| Cd(1)—O(1) | 2.210(5) |
| Cd(1)—O(5)#1 | 2.219(5) |
| Cd(1)—O(3)#2 | 2.297(5) |
| Cd(1)—O(10)#1 | 2.313(5) |
| Cd(1)—O(9)#3 | 2.317(5) |
| Cd(1)—O(4)#2 | 2.357(5) |
| Co(1)—O(6) | 2.065(4) |
| Co(1)—O(7) | 2.069(5) |
| Co(1)—O(8) | 2.093(5) |
| Co(1)—O(2)#4 | 2.104(5) |
| Co(1)—O(10) | 2.121(5) |
| Co(1)—O(9) | 2.387(5) |
| O(1)—Cd(1)—O(5)#1 | 130.35(18) |
| O(1)—Cd(1)—O(3)#2 | 141.22(17) |
| O(5)#1—Cd(1)—O(3)#2 | 88.39(17) |
| O(1)—Cd(1)—O(10)#1 | 86.65(18) |
| O(5)#1—Cd(1)—O(10)#1 | 84.62(18) |
| O(3)#2—Cd(1)—O(10)#1 | 101.0(2) |
| O(1)—Cd(1)—O(9)#3 | 84.61(18) |
| O(5)#1—Cd(1)—O(9)#3 | 85.1(2) |
| O(3)#2—Cd(1)—O(9)#3 | 99.0(2) |
| O(10)#1—Cd(1)—O(9)#3 | 157.20(19) |
| O(1)—Cd(1)—O(4)#2 | 86.04(17) |
| O(5)#1—Cd(1)—O(4)#2 | 143.38(18) |
| O(3)#2—Cd(1)—O(4)#2 | 55.61(17) |
| O(10)#1—Cd(1)—O(4)#2 | 95.1(2) |
| O(9)#3—Cd(1)—O(4)#2 | 105.3(2) |
| O(6)—Co(1)—O(7) | 88.78(19) |
| O(6)—Co(1)—O(8) | 172.0(2) |
| O(7)—Co(1)—O(8) | 84.9(2) |
| O(6)—Co(1)—O(2)#4 | 85.69(18) |
| O(7)—Co(1)—O(2)#4 | 101.7(2) |
| O(8)—Co(1)—O(2)#4 | 90.7(2) |
| O(6)—Co(1)—O(10) | 99.01(18) |
| O(7)—Co(1)—O(10) | 167.0(2) |
| O(8)—Co(1)—O(10) | 88.1(2) |
| O(2)#4—Co(1)—O(10) | 89.26(19) |
| O(6)—Co(1)—O(9) | 92.87(19) |
| O(7)—Co(1)—O(9) | 112.4(2) |
| O(8)—Co(1)—O(9) | 94.1(2) |
| O(2)#4—Co(1)—O(9) | 145.87(19) |
| O(10)—Co(1)—O(9) | 57.23(17) |

Symmetry transformations used to generate equivalent atoms:
#1−x + 1, y − 1/2, −z + 3/2
#2x + 1, y, z
#3−x + 1, −y + 1, −z + 1
#4−x + 1, y + 1/2, −z + 3/2
#5x − 1, y, z

### Example 4: Synthesis of MOFs

A new bimetallic crystalline mixture named BMMOF11 was synthesized by using the hydrothermal method. Cd(NO₃)₂·4H₂O and Co(NO₃)₂·6H₂O and trimesic acid were then dissolved in 10 mL of N, N-dimethylformamide (DMF), and acetic acid (1 mL) was added. Afterward, the mixture was put in an ultrasonicator for 5 min at room temperature. The mixture was kept at 120° C. for 2 days in a 50 mL stainless steel autoclave. Then, the mother liquor was extracted from the formed crystals and was washed with DMF and dichloromethane three times. Finally, the crystals were dried at 80° C. for 6 h yielding the required BMMOF11 in preferably about 55% yield (related to the metal salts). FT-IR (KBr, cm⁻¹): 3380, 1666, 1612, 1534, 1435, 1369, 1105, 932, 771, 717, Anal. Calcd for C₁₅H₁₇CdCON₃O₁₁ [CoCd(BTC)(NO₃)(DMF)₂]: C, 30.71; H, 2.92; N, 7.16. Found: C, 30.84; H, 3.05; N, 7.27.

### Example 5: Electrode Fabrication and Electrochemical Characterizations

For the electrode fabrication, 20 mg of the BMMOF11 was dispersed in 5 ml of water/ethanol (1:1 v/v) solution via ultrasonication for 30 minutes. Later on, 10 μL of Nafion solution was added to the mixture and further sonicated for 15 minutes. Finally, 200 μL of the prepared solution was drop cast on 1 cm² of clean NF and dried at 60° C. in an electric oven for 6 hours. The electrochemical water oxidation activities of the BMMOF11 electrocatalyst were conducted in a three-electrode electrochemical system connected to an electrochemical workstation (CHI-760E), with Ag/AgCl electrode (saturated KCl solution) as the reference electrode, a platinum wire as the counter electrode, and the prepared electrode as the working electrode. Here cyclic voltammetry (CV), amperometry, and electrochemical impedance spectroscopy (EIS) were used for the electrochemical water oxidation activities. All the electrochemical potentials were converted to the reversible hydrogen electrode (RHE) using Equation 1.

$${E}_{( RHE )} = {E}_{( Ag / AgCl )} + {E}_{( Ag / AgCl )}^{o} + 0.059 \times pH \qquad Eq . ( 1 )$$

Where, E_{(Ag/AgCl)}^{o} is equal to 0.1976 V at room temperature.

### Example 6: Crystal Structure of BMMOF11

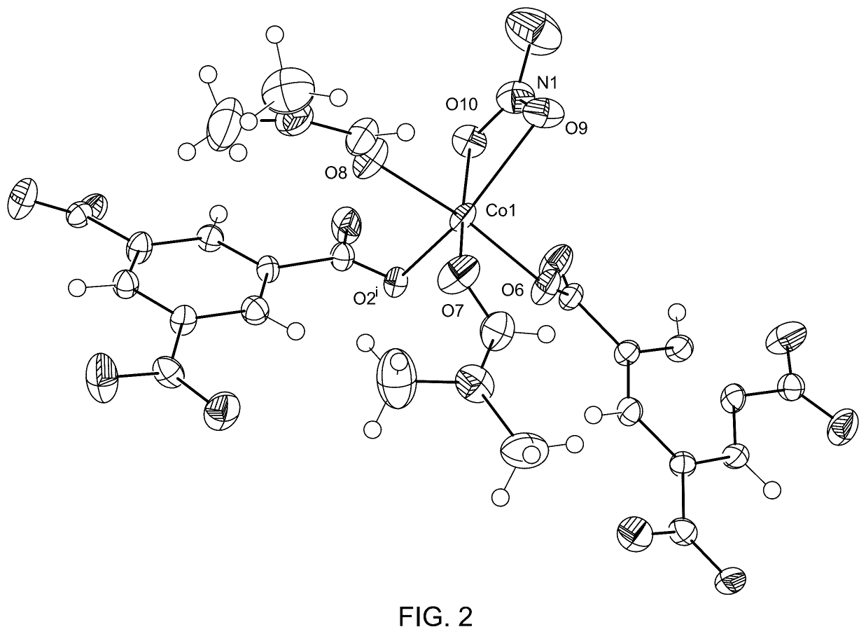

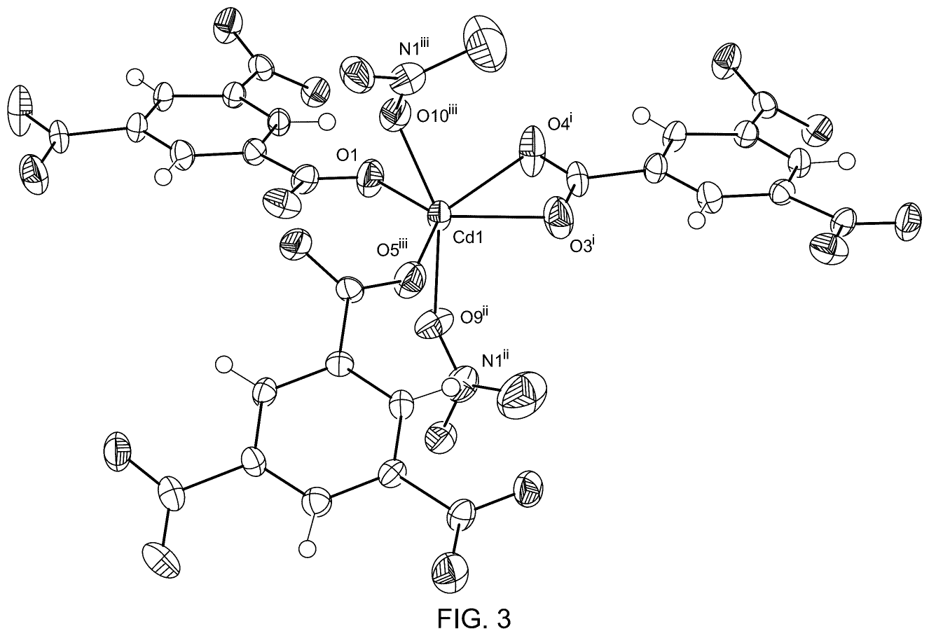

The compound of the formula [CoCd(BTC)(NO₃)(DMF)₂], crystallizes in the monoclinic system with the P2₁/c space group. FIG. 2 is an Oak Ridge Thermal Ellipsoid Plot (ORTEP) diagram of the Co secondary building unit (SBU) in [CoCd(BTC)(NO₃)(DMF)₂]. The asymmetric unit includes one Co(II) and one Cd(II) ion in addition to one benzene-1,3,5-tricarboxylate (BTC) linker, one nitrate anion, and two ligating dimethylformamide molecules. Two carboxylate groups of the BTC linker adopt a bidentate bridging mode Co(μ₂-κ²-O,O)Cd, while the third carboxylate adopts a chelating mode (κ²-O,O)Cd. The nitrate ion simultaneously adopts a chelating mode (κ²-O,O) Co, a bidentate bridging mode Cd(μ²-κ²-O,O)Cd, in addition to a Cd(μ₂-κ¹-O)Co bridging mode. The Co(II) coordination sphere [CoO₆] consists of oxygen donors originating from two DMF molecules, and two carboxylate groups, in addition to the chelating nitrate (FIG. 2), whereas the Cd(II) coordination sphere [CdO₆] comprises oxygen donors belonging to two nitrates, one chelating carboxylate, and two bridging carboxylates (FIG. 3). The bond distances and bond angles are similar to those reported for the MOF [Cd₂Co(BTC)₂(H₂O)₄]·2H₂O [Jian-Xin Chen, Shi-Xiong Liu, En-Qing Gao. Polyhedron 23 (2004) 1877-1888, which is incorporated herein by reference in its entirety]. Alternating and vertex sharing [CdO₆] and [CoO₆] distorted octahedra form zig-zag chains along the direction. These chains are bridged by the BTC linker giving rise to the 3D network. FIG. 4A depicts a single-crystal structure of BMMOF11 constructed from BTC, Co²⁺, and Cd²⁺ building blocks. FIG. 4B depicts a single unit showing the binding of the BTC with Co²⁺ and Cd²⁺, while FIG. 4C depicts an inorganic secondary building unit including Co²⁺ and Cd²⁺.

### Example 7: Powder X-Ray Diffraction (PXRD) Analysis

The PXRD confirmed the crystallinity and phase purity of BMMOF11, as depicted in FIG. 5, demonstrating that it is highly crystalline and single-phase. This structural characterization corroborated the coherence in the connectivity and integrity of the framework between the simulated and the as-synthesized MOF with the characteristic peaks at 2θ=8.8, 10.3, 10.8, and 12.9. The FTIR bands (FIG. 6) at 717 cm⁻¹ and 771 cm⁻¹ correspond to the out-of-plane aromatic C—H bending modes of the linker. The peak at 1105 cm⁻¹ is assigned to the aromatic C—H in-plane bending, whereas the sharp peaks at 1369, 1435 cm⁻¹, and 1534, 1612 cm⁻¹ are most likely attributable to the symmetric and asymmetric C—O stretching modes of the COO— group. The N₂ adsorption isotherms of BMMOF11 at 77 k revealed a sharp surge in the uptake at relatively low pressure, referring to a microporous nature with Type I isotherm. FIG. 7 shows a nitrogen adsorption isotherm of BMMOF11, and the Brunauer-Emmett-Teller (BET) surface area calculated was 584 m²/g. The thermal stability of BMMOF11 was investigated with the help of thermogravimetric analysis (TGA), as shown in FIG. 8. The TGA displayed an abrupt weight loss of about 23.0% at 300° C. and another weight loss of 41.0% at 350° C. associated with the thermal decomposition of the whole framework. The 36.0% final residue accounts for the cobalt and cadmium oxides. The Field Emission Scanning Electron Microscopy (FESEM) image of microcrystalline BMMOF11 shows that it consists of irregular sheets with pointed edges that are stacked one on top of the other, as depicted in FIG. 9.

### Example 8: Electrocatalytic Activity

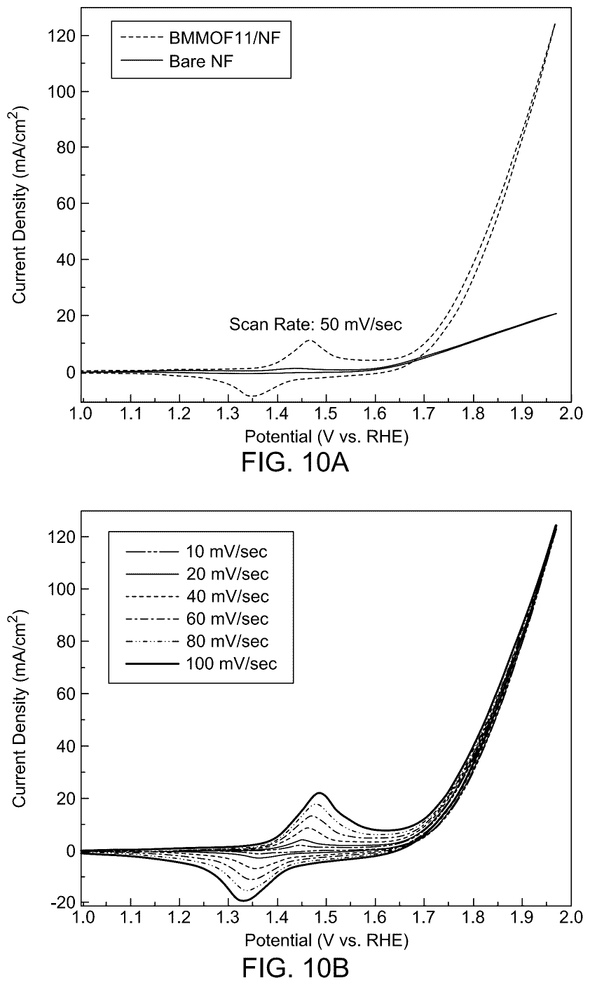

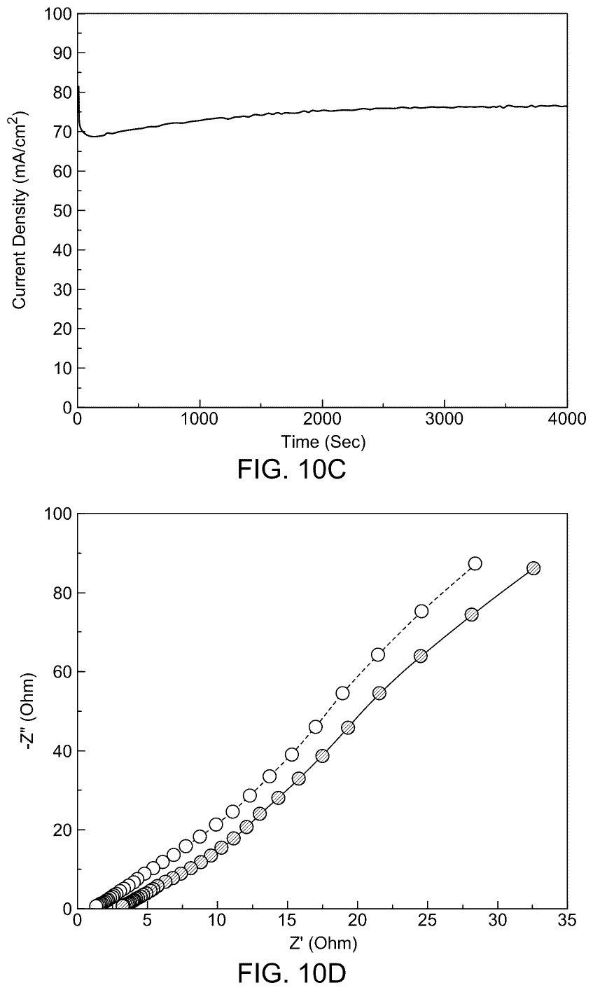

The electrochemical water oxidation activities of the BMMOF11 electrocatalyst were assessed by cyclic voltammetry (CV) analysis, using NF as a substrate in 1 M KOH, at a scan rate of 50 mV/sec. As shown in FIG. 10A, the BMMOF11/NF electrocatalyst has exceptional activity, with a substantially lower overpotential (0.4 V vs. RHE) required to achieve a current density of 10 mA/cm², a standard value in evaluating electrochemical water oxidation catalysts. Similarly, the electrochemical water oxidation on the BMMOF11/NF electrocatalyst exhibits a very low starting potential (˜ 1.62 V vs. RHE). Also, at a high potential (1.9 V vs. RHE), the BMMOF11/NF electrocatalyst achieves a current density of about 124 mA/cm², which is significantly greater than the bare NF (FIG. 9A), and the reported MOFs-based. The CV curves were then recorded at different scan rates from 10 to 100 mV/see (FIG. 10B). At all the applied scan rates (from 10 to 100 mV/sec), there is no such difference in the starting potential, overpotential, and maximum current density at 1.9 V (vs. RHE). Additionally, reaching a current density of 100 mA/cm² at a very low overpotential of 0.6 V (vs. RHE) is also significant for NF-supported electrocatalyst systems. The ability to achieve a high current density at a low overpotential clearly demonstrates the superiority of the prepared electrocatalyst (i.e., BMMOF11/NF). The pre-peaks (redox peaks) in CV curves between 1.3 V and 1.6 V (vs. RHE) represent the oxidation and reduction of the BMMOF11/NF electrocatalyst.

The BMMOF11/NF electrocatalyst was tested for stability in a 1 M KOH aqueous solution at 1.9 V (vs. RHE) for 4000 sec. The stability profile of the sample is shown in FIG. 10C, which further shows the electrocatalyst's strong stability for electrochemical water oxidation. The long-term electrolysis stability test using the BMMOF11/NF electrocatalyst has shown that it can be utilized to continuously split water into O₂ and H₂ at a current density of about 70 mA/cm² with an applied voltage of 1.9 V vs. RHE. As evident from the stability profile, the electrocatalyst is perfectly stable at such a high potential which further elaborates the excellent approach of the BMMOF11/NF electrocatalyst towards electrochemical water oxidation. The electrochemical performance was further evaluated by the EIS analysis, as shown in FIG. 10D, there is very little deviation in the Nyquist plot of the BMMOF11/NF electrocatalyst before and after stability performance. Also, the BMMOF11/NF electrocatalyst exhibited a minimal solution resistance of ˜1.3Ω, which was increased to ˜2.3Ω after stability. The minimal existence of semicircles and good straight-line slope at low-frequency regions in the Nyquist plots also show very little charge transfer resistance and good diffusion of electrolyte ions in the pores of the BMMOF11/NF electrocatalyst, which are beneficial for excellent electrochemical performance. By considering the above-mentioned parameters, the BMMOF11/NF electrocatalyst is a superior electrocatalyst for electrochemical water oxidation. These findings demonstrate that the BMMOF11 can support water oxidation for various real-world uses, including producing pure H₂ and O₂ and converting CO₂ into valuable renewable fuel.

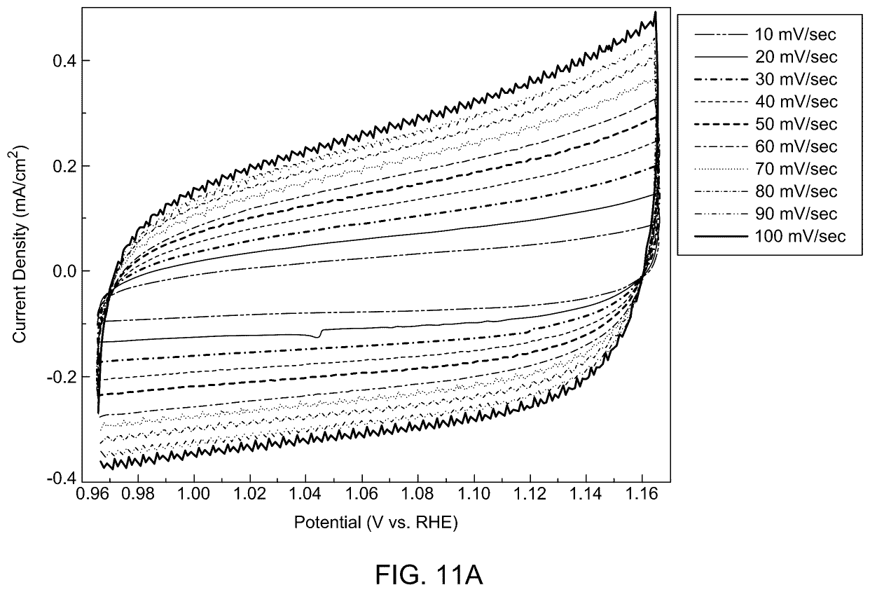

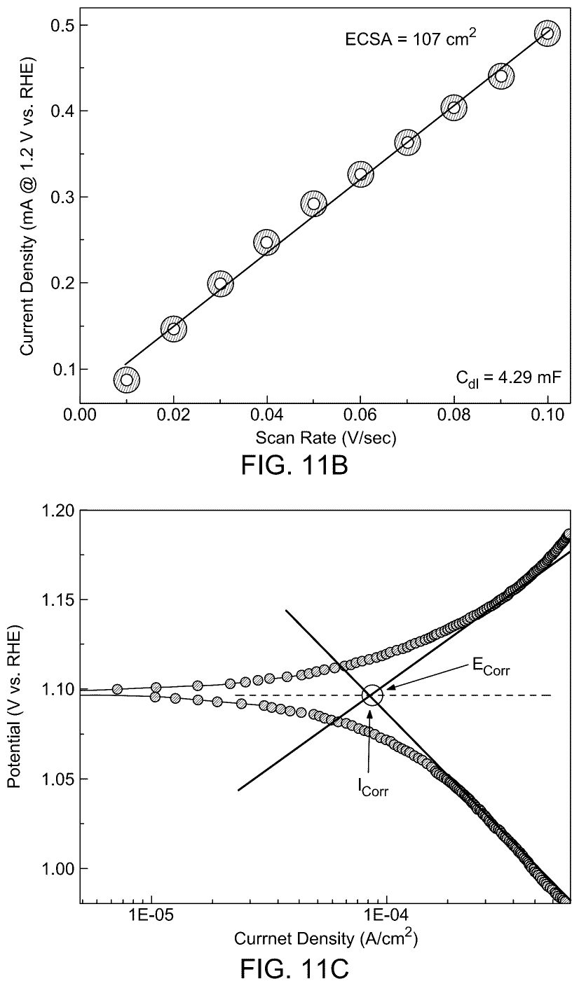

Using the CV analysis in the non-Faradaic zone, the electrochemical surface areas (ECSA) of the BMMOF11/NF electrocatalyst were calculated from its double-layered capacitance (C_{dl}) [Charles C. L. McCrory, Suho Jung, Jonas C. Peters, Thomas F. Jaramillo, J. Am. Chem. Soc. 2013, 135, 45, 16977-16987, which is incorporated herein by reference in its entirety]. The charging of the double layer is the source of the current that is generated in the non-Faradaic zone, and it was found to have a linear connection with the amount of active surface area. As shown in FIG. 11A, the CV curves were recorded in the operating potential window between 0.97 V and 1.16 V (vs. RHE) in the aqueous solution of 1 M KOH at different scan rates from 10 to 100 mV/sec. It is reported that a 1 cm² flat surface area has a specific capacitance (Cₛ) value that ranges from 0.02 to 0.06 mF/cm², with an average value of 0.04 mF/cm². The Eq. (2) has been used to convert the C_{dl} value to the ECSA [Wael Mahfoz, Md. Abdul Aziz, Syed Shaheen Shah, Abdul-Rahman Al-Betar Chem. Asian J. 2020, 15, 4358-4367, which is incorporated herein by reference in its entirety].

$$ECSA = \frac{{C}_{dl}}{{C}_{s}} \qquad ( 3 )$$

In FIG. 11B, the slope of the straight line represents C_{dl} which is equal to 4.29 mF. Using Eq. (3) and the aforementioned C_{dl} and Cₛ values, the ECSA was calculated for the BMMOF11/NF electrocatalyst, which was ˜107 cm². Further, the electrochemical activity evaluation of the BMMOF11/NF electrocatalyst was examined via the Tafel plot. As can be observed from FIG. 11C, the BMMOF11/NF electrocatalyst exhibits a higher electropositive corrosion potential (Ecorr) of ˜1.09 V vs. RHE, and the corrosion current density (Icorr) of the BMMOF11/NF electrocatalyst is about 86 μA/cm², which shows a high corrosion resistance. Furthermore, the BMMOF11/NF electrocatalyst demonstrated an anodic Tafel slope (βₐ) of ˜85 mV/decade and a cathodic Tafel slope (β_{c}) of about 135 mV/decade, which further confirms that the BMMOF11/NF is an improved electrocatalyst for water oxidation.

To conclude, a bimetallic Co and Cd metal based on MOF (BMMOF11) electrocatalyst has been synthesized and described in the present disclosure. The BMMOF11 was immobilized on NF for electrochemical measurements and shows excellent electrocatalytic properties towards electrochemical water oxidation in 1 M KOH aqueous solution. The developed BMMOF11/NF electrocatalyst delivered excellent electrochemical performance by producing a high current density of ˜124 mA/cm² at 1.9 V vs. RHE and lower overpotential. The BMMOF11/NF electrocatalyst also shows good stability in electrochemical water oxidation at high potential and high current density. Such high-efficiency BMMOF11/NF electrocatalyst could be suitable for large-scale water splitting and other electrochemical applications, including producing clean H₂ and O₂ and converting CO₂ to valuable fuels.

Numerous modifications and variations of the present disclosure are possible in light of the above teachings. It is therefore to be understood that within the scope of the appended claims, the invention may be practiced otherwise than as specifically described herein.

1: An electrode comprising a Co/Cd MOF electrocatalyst, comprising:
a metallic substrate; and
a layer of a cobalt (Co) and cadmium (Cd) doped bimetallic metal-organic framework (BMMOF11) material at least partially covering a surface of the metallic substrate;
wherein Co and Cd ions are uniformly distributed throughout a microporous matrix of the BMMOF11 material; and
wherein the BMMOF11 material comprises irregular shaped microcrystalline structures with pointed edges, and wherein the irregular shaped microcrystalline structures are in the form of sheets that are stacked on top of one another.

2: The electrode of claim 1, wherein the metallic substrate is at least one metal foam selected from the group consisting of an aluminum foam, a nickel foam, a titanium foam, a titanium alloy foam, an aluminum alloy foam, a magnesium alloy foam, a nickel alloy foam, and a steel foam.

3: The electrode of claim 1, wherein the metallic substrate is a nickel foam.

4: The electrode of claim 1, wherein the BMMOF11 material has a formula [CoCd(BTC)(NO₃)(DMF)₂], wherein BTC is a tricarboxylate linker that is covalently bonded to at least one Co ion and at least one Cd ion at the same time.

5: The electrode of claim 1, wherein the layer of the BMMOF11 material has an average pore size of 0.5 to 10 micrometers (μm).

6: The electrode of claim 1, wherein the BMMOF11 material is a crystalline material having a single crystal lattice structure.

7: The electrode of claim 1, having a current density of about 120 to 130 milliamperes per square centimeter (mA/cm²) at 1.9 volts relative to the reversible hydrogen electrode (V_{RHE}).

8: The electrode of claim 1, having an electrochemical water oxidation starting potential of about 1.62 V_{RHE}.

9: The electrode of claim 1, having an overpotential of about 0.4 V_{RHE} for a current density of 10 mA/cm².

10: A method of making the electrode of claim 1, comprising:
mixing and dissolving particles of the BMMOF11 material in a solvent to form a solution;
aerosolizing the solution to form an aerosol;
placing the metallic substrate in a heating chamber, and passing the aerosol through the heating chamber with the aid of a carrier gas;
wherein the carrier gas comprises nitrogen;
wherein the metallic substrate is in direct contact with the aerosol; and
heating the metallic substrate in the heating chamber to form the electrode having the layer of the BMMOF11 material at least partially covered on the surface of the metallic substrate.

11: The method of claim 10, wherein the solvent is at least one selected from the group consisting of a ketone solvent, an ester solvent, an alcohol solvent, an amide solvent, and an ether solvent.

12: The method of claim 10, wherein the aerosolizing homogeneously disperses particles of the BMMOF11 material on the surface of the metallic substrate.

13: The method of claim 10, wherein the aerosolizing is performed with an aerosol generator, comprising:
a fluid chamber having a housing inlet, a housing outlet, and a vent;
a vibrating element operably coupled to the support plate for generating the aerosol;
wherein the solution is introduced into the fluid chamber via the housing inlet;
wherein the fluid chamber is in fluid communication with the heating chamber via the housing outlet; and
wherein the carrier gas is introduced into the fluid chamber via the vent, thereby carrying the aerosol into the heating chamber.

14: The method of claim 10, further comprising forming the BMMOF11 material by:
mixing a Co salt, a Cd salt and a tricarboxylate linker in N,N-dimethylformamide (DMF) to form a mixture and heating;
wherein a molar ratio of the Co ion to the Cd ion is about 1:1;
wherein a molar ratio of the tricarboxylate linker to a total number of moles of the Co salt and the Cd salt is about 1:6;
cooling the mixture after the heating thereby allowing the BMMOF11 material to precipitate from the mixture; and
removing the BMMOF11 material in the form of a precipitate from the mixture, washing and drying.

15: The method of claim 14, wherein the Co salt comprises cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or its hydrate.

16: The method of claim 14, wherein the Cd salt comprises cadmium sulfate, cadmium acetate, cadmium citrate, cadmium iodide, cadmium chloride, cadmium perchlorate, cadmium nitrate, cadmium phosphate, cadmium triflate, cadmium bis(trifluoromethanesulfonyl)imide, cadmium tetrafluoroborate, cadmium bromide, and/or its hydrate.

17: A method of electrochemical water splitting, comprising;
applying a potential of greater than 0 to 2.0 V_{RHE} to an electrochemical cell to form hydrogen and oxygen; and
separately collecting H₂-enriched gas and O₂-enriched gas,
wherein the electrochemical cell comprises the electrode of claim 1, and a counter electrode; and
wherein the electrochemical cell is at least partially submerged in an electrolyte.

18: The method of claim 17, wherein the counter electrode is made from a material selected from the group consisting of platinum, gold, and carbon.

19: The method of claim 17, wherein the electrolyte comprises an aqueous solution of a base at a concentration of 0.1 to 3 M.

20: The method of claim 19, wherein the base is at least one selected from the group consisting of NaOH, KOH, LiOH, Ba(OH)₂, and Ca(OH)₂.
